(19) United States
(12) Patent Application Publication
(10) Pub. No.: US 2008/0181605 A1
(43) Pub. Date: Jul. 31, 2008

(54) MULTI-DEGREE OPTICAL NODE ARCHITECTURES

(76) Inventors: Paparao Palacharla, Richardson, TX (US); Daniel Bihon, Plano, TX (US); Takao Naito, Plano, TX (US)

Correspondence Address: BAKER BOTTS L.L.P., 2001 ROSS AVENUE, SUITE 600, DALLAS, TX, 75201-2980, US

(21) Appl. No.: 11/668,770

(22) Filed: Jan. 30, 2007

(51) Int. Cl. H04J 14/00

(52) U.S. Cl. 398/50; 398/48

(57) ABSTRACT

An optical node includes a plurality of optical input components operable to receive a plurality of signals communicated in an optical mesh network. A plurality of optical drop components coupled to the plurality of optical input components, each optical drop component operable to select a signal to drop to one or more associated client devices from any one of the plurality of optical input components. A plurality of optical output components operable to transmit a plurality of signals to be communicated in the optical mesh network, and a plurality of optical add components coupled to the plurality of optical output components and operable to transmit copies of a plurality of optical add signals to the plurality of optical output components. Each optical output component is operable to select a signal to communicate in the optical mesh network received from any one of the plurality of optical add components and the plurality of optical input components.

### TECHNICAL FIELD OF THE INVENTION

The present invention relates generally to optical networks and, more particularly, to multi-degree optical node architectures.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss of signal strength.

In recent years, the use of telecommunication services has increased dramatically. As the demand for telecommunication services continue to grow, various topologies of optical networks are emerging. For example, ring network topologies are evolving into mesh network topologies. Ring network topologies have several inefficiencies, such as information having to travel through each intermediate node before reaching the destination node and the fallibility of the entire ring network if there are multiple failures. Mesh network topologies provide several benefits over a ring network. While the network topology can be improved, existing optical node architectures are not efficient and effective in mesh network topologies. For example, conventional optical node architectures are not scalable to support the increased connectivity of optical nodes in mesh network topologies.

### SUMMARY

In accordance with the present invention, disadvantages and problems associated with conventional optical node architectures in mesh network topologies may be reduced or eliminated.

According to one embodiment of the present invention, an optical node includes a plurality of optical input components operable to receive a plurality of signals communicated in an optical mesh network. A plurality of optical drop components coupled to the plurality of optical input components, each optical drop component operable to select a signal to drop to one or more associated client devices from any one of the plurality of optical input components. A plurality of optical output components operable to transmit a plurality of signals to be communicated in the optical mesh network, and a plurality of optical add components coupled to the plurality of optical output components and operable to transmit copies of a plurality of optical add signals to the plurality of optical output components. Each optical output component is operable to select a signal to communicate in the optical mesh network received from any one of the plurality of optical add components and the plurality of optical input components.

Technical advantages of one or more embodiments of the present invention may include multi-degree optical node architectures that are scalable in mesh network topologies. The optical node architectures support multi-degree connectivity, dynamic light path provisioning, and mesh protection and restoration. Furthermore, the multi-degree optical node architectures are less cumbersome and less complex than conventional optical node architectures in a mesh network.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a mesh optical network;

FIG. 2 is a block diagram illustrating a node in the mesh network of FIG. 1 having a multi-degree architecture according to a particular embodiment of the present invention;

FIG. 3 is a block diagram illustrating another embodiment of a node having a multi-degree architecture for use in the mesh network; and

FIG. 4 is a block diagram illustrating yet another embodiment of a node in the mesh network having a multi-degree architecture that also includes an optical loop back.

### DETAILED DESCRIPTION

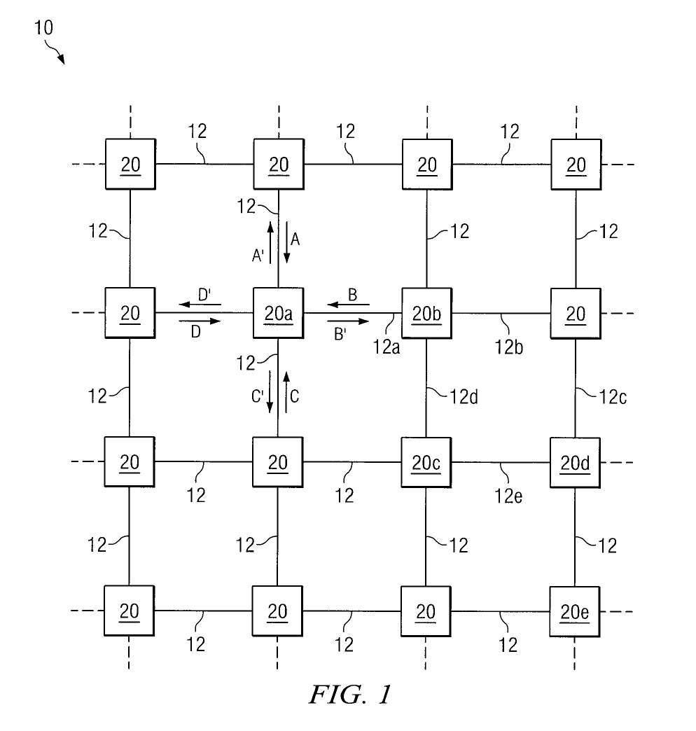

FIG. 1 is a block diagram illustrating a mesh optical network 10. Mesh optical network 10 includes one or more optical fibers 12 operable to transport one or more optical signals communicated by components of mesh network 10. The components of mesh network 10, coupled together by optical fibers 12, include a plurality of nodes 20. In the illustrated network 10, each node 20 is coupled to four other nodes to create a mesh. However, any suitable configuration of any suitable number of optical nodes 20 may create mesh network 10. For example, one or more nodes 20 in mesh network 10 may have less or more interconnections with other nodes 20. Mesh network 10 may represent all or a portion of a short-haul metropolitan network, a long-haul inter-city network, and/or any other suitable network or combination of networks. Optical fibers 12 represent any suitable type of fiber. For example, the optical fiber coupling two nodes 20 may comprise, as appropriate, a single uni-directional fiber, a single bi-directional fiber, or a plurality of uni- or bi-directional fibers. More particularly, optical fiber 12 may include a Single-Mode Fiber (SMF), Enhanced Large Effective Area Fiber (E-LEAF), TrueWave® Reduced Slope (TW-RS) fiber, or other suitable fiber.

As mentioned above, mesh network 10 may be operable to communicate optical signals carrying information from one node 20 to one or more other nodes 20. In particular, mesh network 10 may allow client devices (not shown) coupled to a node 20 to communicate with one or more other client devices coupled to one or more of the other nodes 20.

Mesh network 10 communicates information or “traffic” over optical fibers 12. As used herein, “traffic” means information transmitted, stored, or sorted in mesh network 10. Such traffic may comprise optical signals having at least one characteristic modulated to encode audio, video, textual, and/or any other suitable data. The data may also be real-time or non-real-time. Modulation may be based on phase shift keying (PSK), intensity modulation (IM), or other suitable methodologies. Additionally, the traffic communicated in mesh network 10 may be structured in any appropriate manner including, but not limited to, being structured in frames, packets, or an unstructured bit stream.

Traffic may be carried in a single optical signal that comprises a number of optical channels or wavelengths. The process of communicating traffic at multiple channels of a single optical signal is referred to in optics as wavelength division multiplexing (WDM). Dense wavelength division multiplexing (DWDM) refers to multiplexing a larger (denser) number of wavelengths, usually greater than forty, into a fiber. The optical signal includes different channels combined as a single signal on optical fiber 12. WDM, DWDM, or other suitable multi-channel multiplexing techniques are employed in optical network 10 to increase the aggregate bandwidth per optical fiber 12. Without WDM or DWDM, the bandwidth in network would be limited to the bit rate of only one wavelength. With more bandwidth, optical networks are capable of transmitting greater amounts of information. For example, node 20 in mesh network 10 is operable to transmit and receive disparate channels using WDM, DWDM, or other suitable multi-channel multiplexing technique.

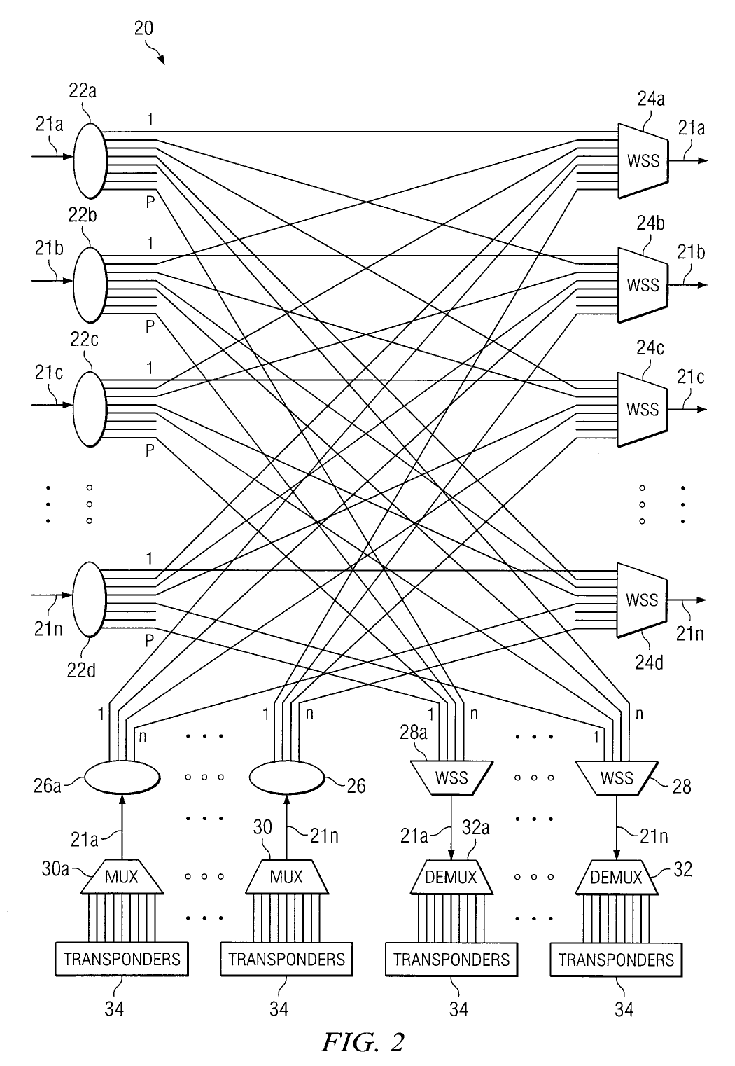

Nodes 20 in mesh network 10 may comprise any suitable nodes operable to transmit and receive traffic in a plurality of channels. In the illustrated embodiment, each node 20 may be operable to transmit traffic directly to four other nodes 20 and receive traffic directly from the four other nodes 20. For example, as illustrated in FIG. 1, node 20a may be capable of receiving input signals A-D from four nodes 20 and forwarding output signals A′-D′ to the four nodes 20. Each output signal, A′-D′, can include traffic in one or more channels from one or more of the input signals and/or traffic added at node 20a. In particular embodiments, nodes 20 include multi-degree architectures that are scalable with mesh optical network 10. Nodes 20 will be discussed in more detail below with respect to FIGS. 2-4.

Nodes 20 in mesh network 10 may use any suitable route to transmit traffic to a destination node 20. As discussed above, fibers 12 may each be a single uni-directional fiber, a single bi-directional fiber, or a plurality of uni- or bi-directional fibers. For example, node 20a transmitting traffic to node 20d may transmit the traffic over fibers 12a, 12b, and 12c or, alternatively, over fibers 12a, 12d, and 12e. Many other paths are possible. Therefore, if fiber 12b fails, node 20a may continue to transmit traffic to node 20d over an alternate path. Fibers 12 may fail or break for any number of reasons, such as being cut, being tampered with, or other occurrences. Furthermore, one or more nodes or other equipment in a path may fail. Mesh network 10 addresses the possibility of failing fibers and/or equipment by allowing flexibility in transmitting traffic between nodes 20.

One challenge faced by those attempting to implement a mesh network topology rather than a ring network topology is existing optical node architectures for a mesh network topology. Particular current node architectures include photonic cross-connect architectures and multi-degree reconfigurable optical add/drop multiplexer (ROADM) architectures based on Wavelength Selective Switches (WSS). A limitation of the ROADM nodes is that these nodes can only support up to eight degrees (or eight connections with other nodes). Additionally, the ROADM nodes have only local add/drop capability for each degree. A limitation of the photonic cross-connect architecture is scalability. For example, for a photonic cross-connect node to support eight degrees, a large 640×640 switch is needed to handle the multiple degrees. For these reasons, a conventional ROADM node and a conventional photonic cross-connect node cannot fully support dynamic provisioning (directing traffic to any suitable fiber), mesh protection, and mesh restoration. FIGS. 2-4 describe a node architecture that interoperates with the increased flexibility of mesh network 10 and supports dynamic provisioning and mesh restoration.

Modifications, additions, or omissions may be made to mesh network 10 without departing from the scope of the disclosure. The components and elements of mesh network 10 described may be integrated or separated according to particular needs. Moreover, the operations of mesh network 10 may be performed by more, fewer, or other components.

FIG. 2 is a block diagram illustrating a node 20 in mesh network 10 of FIG. 1 having a multi-degree architecture. Node 20 addresses the challenges discussed above with respect to use of conventional node architectures in mesh network 10. Node 20 offers a node architecture that provides increased flexibility and full connectivity for traffic. Node 20 may also support dynamic provisioning and mesh restoration. As will be discussed below, traffic may be received on any input fiber 21 and sent on any output fiber 21 using the architecture of node 20. Additionally, the architecture of node 20 is also scalable to allow the addition of degrees (inputs and outputs), as needed.

In the illustrated embodiment, node 20 includes splitters 22 and 26, WSSs 24 and 28, multiplexers 30, demultiplexers 32, and transponders 34 coupled to form a flexible, multi-degree node architecture. Splitters 22 and 26 represent optical couplers or any other suitable optical component operable to split an optical signal into multiple copies of the optical signal and transmit the copies to other components within node 20. In the illustrated embodiment, each splitter 22 may receive an input signal from mesh network 10 and each splitter 26 may receive an optical signal added at node 20. Splitters 22 and 26 may be configured to receive traffic over a particular fiber and split the received traffic into multiple copies. For example, splitters 22 are configured to receive traffic over input fibers 21 and to split the traffic into P copies. Splitters 26 are configured to receive traffic from associated multiplexers 30 and split the traffic into n copies. Multiplexers 30 represent any suitable optical component operable to receive and combine add traffic in disparate optical channels, transmitted by associated transponders 34 from one or more client devices, into a WDM or other optical signal for communication to splitter 26.

Splitters 26 are included on the add side of node 20 to support full connectivity for traffic being added by node 20. Having splitters 26 on the add side of node 20 supports the flexibility of transmission desired in mesh network 10. Each splitter 26 receives traffic from a multiplexer 30 and may be configured to pass a copy of the traffic to each WSS 24 over a fiber, port, or other connection. During operation, splitters 26 may pass traffic to WSSs 24 to be transmitted over another fiber 21. Therefore, traffic may continue to be added from transponders 34 even if a fiber 21 fails. For example, if traffic is previously transmitted over fiber 21a but fiber 21a fails, splitter 26a may forward traffic to be transmitted over another operable fiber, such as fiber 21c.

WSSs 24 and 28 may comprise any suitable optical components operable to receive multiple optical signals and output a portion or all of one or more of the received signals. In the illustrated embodiment, WSSs 24 receive copies of one or more add signals from splitters 26 and WSSs 28 receive copies of one or more input signals from splitters 22.

WSSs 28 are included on the drop side of node 20 to support full connectivity for traffic being dropped at node 20. Each WSS 28 may be configured to pass traffic received over a particular fiber 21 to an associated demultiplexer 32. During operation, WSSs 28 may be reconfigured to pass traffic from another fiber to the associated demultiplexers 32 (and then to associated transponders 34). Therefore, any transponder 34 may receive traffic from any input fiber, which supports the flexibility desired in mesh network 10. Demultiplexers 32 represent any demultiplexers or other optical component operable to separate the disparate channels of WDM, DWDM, or other suitable multi-channel optical signals. Demultiplexers 32 are operable to receive an optical signal carrying a plurality of multiplexed channels from WSS 28, demultiplex the disparate channels in the optical signal, and pass the disparate channels to associated transponders 34 (for communication to one or more client devices). Transponders 34 represent any suitable optical components operable to transmit and/or receive traffic on a channel. Transponders 34 communicate traffic to and from client devices.

In operation, each splitter 22 in node 20 may receive a WDM or other multi-channel input optical signal from mesh network 10. Splitter 22 splits the received input signal into several copies. A copy of the input signal is transmitted to each WSS 24 (where some or all of the channels may be passed through node 20 to mesh network 10) and transmitted to each WSS 28 (where some or all of the channels may be dropped at node 20). WSS 24 does signal (wavelength) blocking and/or filtering. For example, each WSS 24 is configured to select one or more of the signals (wavelengths) received from splitters 22 (pass-through) and/or one or more of the signals (wavelengths) received from splitters 26 (add) for communication to network 10. Each WSS 28 is configured to drop traffic received from a particular input fiber 21 to an associated demultiplexer 32. Each demultiplexer 32 receives the traffic, separates the traffic into the constituent channels, and drops each channel to its associated transponder 34. For example, splitter 22a receives traffic over input fiber 21a. Splitter 22a copies the traffic and transmits a copy to each WSS 24 and each WSS 28. In the illustrated embodiment, WSS 28a may be configured to transmit traffic received over input fiber 21a to demultiplexer 32a. In such a case, WSS 28a receives copies of each input signal, but selects the signal received over fiber 21a for transmission to demultiplexer 32a. Demultiplexer 32a transmits the traffic to transponders 34 for communication to one or more client devices.

If a fiber or equipment failure prevents the receipt of traffic over input fiber 21, the architecture of node 20 provides for mesh protection and restoration. In mesh network 10, traffic may be re-routed to node 20 of FIG. 2 on another input fiber 21. As mentioned above, each WSS 28 receives a copy of traffic from each splitter 22. WSS 28 may be reconfigured to pass traffic received from another fiber 21 to the associated demultiplexer 32 and transponders 34, which allows the client device(s) to continue receiving traffic even if a fiber 21 fails. Referring to the above example, if fiber 21a fails or traffic is otherwise prevented from being received on fiber 21, the traffic transmitted on fiber 21a may be rerouted to fiber 21c and still reach the appropriate client device(s). In this example, WSS 28a is configured to pass traffic received over fiber 21c, rather than fiber 21a. WSS 28a receives the traffic transmitted on fiber 21c from splitter 22c and passes the traffic on fiber 21c to demultiplexer 32a. Demultiplexer 32a transmits the traffic to transponders 34, and the traffic is transmitted to the client device(s). Therefore, the client device(s) receive the traffic even though fiber 21a has an associated failure.

As mentioned above, node 20 may also add traffic to mesh network 10. Transponders 34 may transmit such traffic to an associated multiplexer 30, which combines traffic in multiple channels into a WDM signal and transmits the WDM signal to the associated splitter 26 over a fiber 21. Splitter 26 creates copies of the signal and transmits a copy to each WSS 24. As mentioned above, each WSS 24 may be configured to transmit a particular received signal over a particular output fiber 21. WSS 24 forwards the selected signal to mesh network 10 over the particular fiber 21.

The architecture of node 20 may also improve the flexibility of adding signals to node 20 from client devices. If a fiber or equipment failure occurs, the architecture of node 20 allows add traffic that was previously being output via one output fiber 21 to be output from another output fiber 21, which provides for mesh protection and restoration. For example, multiplexer 30a transmits an added signal to be transmitted on fiber 21a to splitter 26a. Splitter 26a copies the added signal and provides a copy to each WSS 24. Referring to the above example, if fiber 21a fails, the traffic transmitted on fiber 21a may be rerouted to fiber 21c. Because splitter 26a provides copies of the traffic to each WSS 24, WSS 24c may be configured to output the particular add signal from splitter 26a onto fiber 21c.

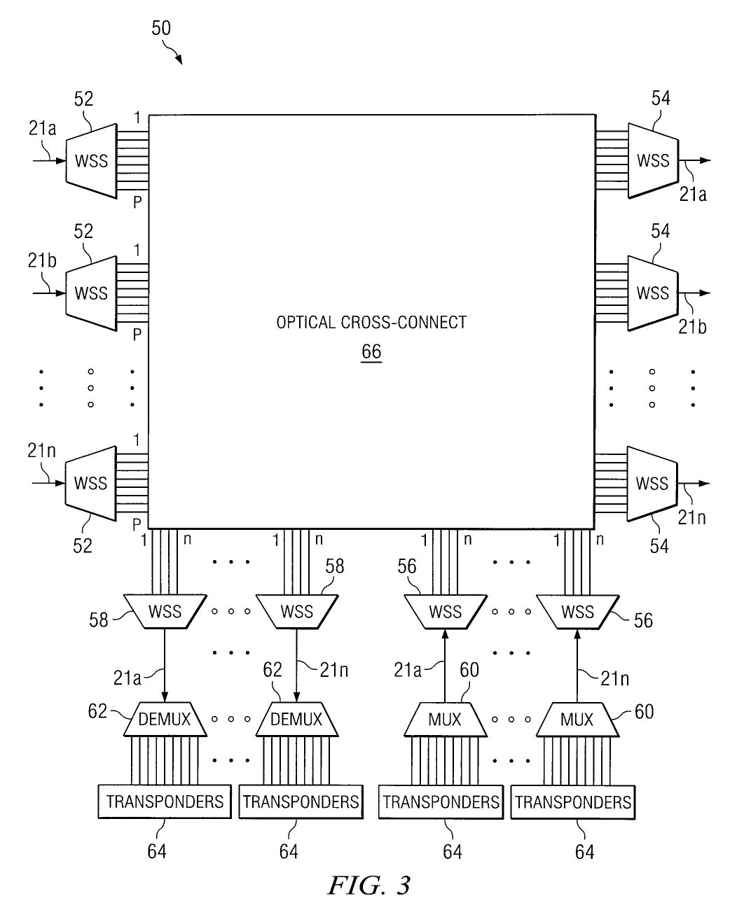

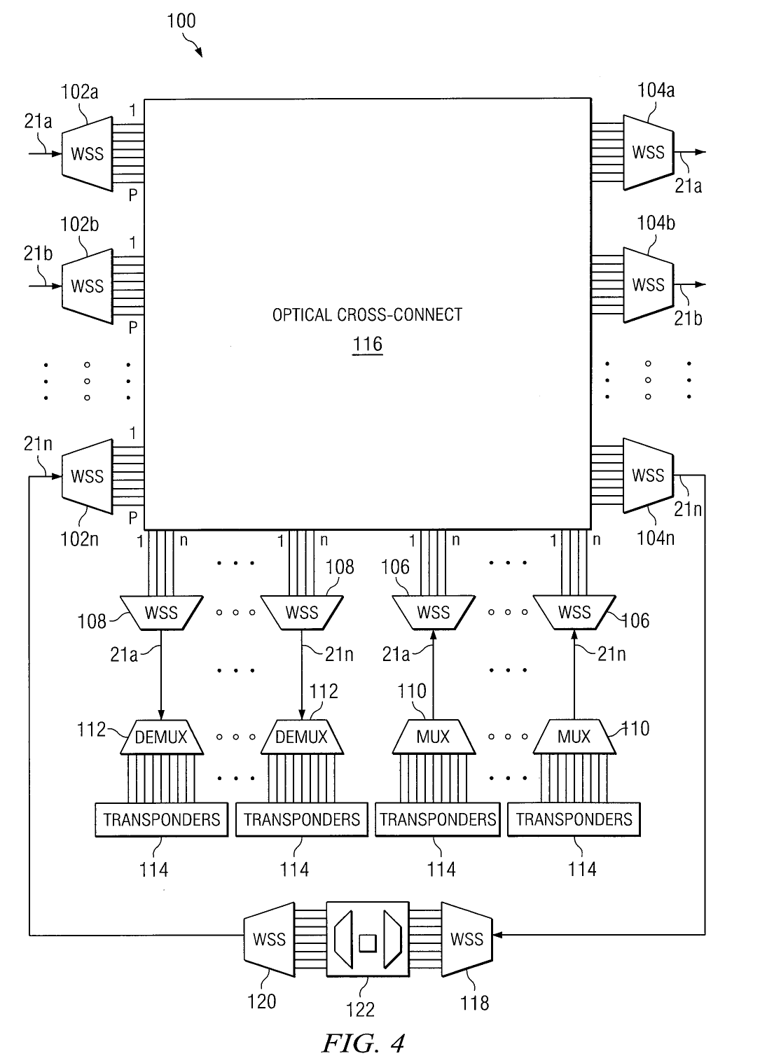

Modifications, additions, or omissions may be made to node 20 illustrated in FIG. 2. For example, multiplexers 30 and demultiplexers 32 may be replaced with WSSs for dynamic optical add/drop multiplexing capability. As another example, splitters 22 and 26 may be replaced with WSSs. Node 20 may include any suitable number of splitters 22 and 26 and WSSs 24 and 28 to handle any suitable number of degrees of node 20. As yet another example, splitters 22 and 26 and WSSs 24 and 28 may be a hierarchical combination of devices to provide a higher number of splitter or WSS inputs or outputs to enable node scalability to higher degrees. For example, splitters 22 and 26 may be a combination of cascaded couplers or a combination of a coupler and two or more WSSs arranged hierarchically. As another example, WSSs 24 and 28 may be a combination of a coupler and two or more WSSs arranged hierarchically or a combination of cascaded WSSs. Fiber interconnections may be replaced by an optical cross-connect as shown in FIG. 3. Node 20 may also include an optical loop back, as will be discussed in FIG. 4 with respect to node 100, to provide optical wavelength conversion, 3R regeneration, traffic grooming, and/or other suitable advantages provided by an optical loop back. The components of node 20 may be integrated or separated according to particular needs. Moreover, the operations of node 20 described may be performed by more, fewer, or other components without departing from the scope of the present disclosure.

FIG. 3 is a block diagram illustrating another embodiment of a node 50 having a multi-degree architecture for use in mesh network 10. Node 50 also addresses the challenges of node architectures in mesh network 10 in a similar manner as node 20, discussed above with respect to FIG. 2. Node 50 offers a node architecture that provides increased flexibility and full connectivity for traffic. Node 50 may also support dynamic provisioning and mesh restoration, and provides for the addition of degrees to node 50, as needed. Node 50 is similar to node 20, except that node 50 employs an optical cross-connect instead of numerous fiber connections between components (it also employs WSSs instead of splitters, which as described above, may also be done in node 20).

WSSs 52, 54, 56, and 58, multiplexers 60, demultiplexers 62, and transponders 64 may function in a similar manner to splitters 22, WSSs 24, splitters 26, WSSs 28, multiplexers 30, demultiplexers 32, and transponders 34, respectively, described above in conjunction with FIG. 2 and thus will not be described again. Unlike splitters 22 and 26, WSSs 52 and 58 do not copy an input signal, but selectively transmit particular channels of the input signal to one or more of its outputs.

Optical Cross-Connect switch (OXC) 66 may be operable to forward traffic from any input fiber 21 to any output fiber 21. OXC 66 is any suitable optical device that provides for switching in the optical domain. OXC 66 in node 50 provides for dynamic reconfigurability in case of partial mesh connectivity within the node. For example, OXC 66 may remotely configure the pattern of connectivity between WSSs 52, 54, 56, and 58. In pre-existing nodes, using an OXC in high-degree nodes is difficult because the OXC would be a large size. For node 50, a smaller size OXC may be used in high-degree nodes. In the illustrated embodiment, to achieve full mesh connectivity between input and output fibers 21 and 100% add/drop, P=2n. The size of OXC 66 would be 2 nP×2 nP. To achieve partial mesh connectivity between input and output fibers 21 and 50% add/drop, P<2n, and the size of OXC 66 would be 1.5 nP×1.5 nP.

Node 50 may operate in a similar manner to node 20, described above in conjunction with FIG. 2. Therefore, the operation of node 50 will not be described again. OXC 66 facilitates the operation of node 50 by directing traffic between fibers 21 as WSSs 56 and 58 are configured and reconfigured to address fiber and/or equipment failures causing traffic to be rerouted in network 10 and thus needing to be rerouted in node 50.

Modifications, additions, or omissions may be made to node 50. For example, node 50 may include any suitable number of WSSs 52, 54, 56, and 58 to handle the addition of degrees to node 50. As another example, WSSs 52 and 56 may be replaced with splitters. As yet another example, node 50 may include more than one OXC 66 to enable redundancy. If node 50 includes a pair of OXC 66 cards, node 50 may include a splitter or a switch coupled to each WSS that communicates traffic to/from the splitter or switch and both OXC 66 cards. For example, each output of a WSS 52 may be coupled to a splitter to forward the traffic on the fiber to each OXC 66 card. Each input of a WSS 58 may be coupled to a switch that receives traffic from each OXC 66 card, and transmits the traffic from one of the OXCs 66 to WSS 58. The components of node 50 may be integrated or separated according to particular needs. Moreover, the operations of node 50 described may be performed by more, fewer, or other components without departing from the scope of the present disclosure.

FIG. 4 is a block diagram illustrating yet another embodiment of a node 100 having a multi-degree architecture that also includes an optical loop back. Node 100 also addresses the challenges of node architectures in mesh network 10 in a similar manner as node 20, discussed above with respect to FIG. 2. In addition to the advantages provided by node 20, the inclusion of an optical loop back in node 50 also provides for optical wavelength conversion, 3R regeneration (which regenerates the signal through amplification, reshaping, and re-timing), traffic grooming, and/or other suitable advantages provided by an optical loop back.

WSSs 102, 104, 106, and 108, multiplexers 110, demultiplexers 112, and transponders 114 may function in a similar manner to splitters 22, WSSs 24, splitters 26, WSSs 28, multiplexers 30, demultiplexers 32, and transponders 34, respectively, described above in conjunction with FIG. 2 and thus will not be described again. OXC 116 may be the same as OXC 66 described above in conjunction with FIG. 3 and will not be described again. Unlike splitters 22 and 26, WSSs 102 and 106 do not copy an input signal, but selectively transmit particular channels of the input signal to one or more of its outputs.

WSSs 118 and 120 operate in a similar manner as discussed with respect to WSSs 22 and 24 as described above in conjunction with FIG. 2 and will not be described again. WSS 118 may be coupled to a traffic regenerator 122 for each wavelength, and the traffic regenerator 122 may be coupled to WSS 120. Traffic regenerator 122 represents any suitable component operable to regenerate traffic that has been traveling in mesh network 10 and/or to otherwise modify the traffic. For example, regenerator 122 may include a transponder, a tunable transponder, or other suitable component. Regenerator 122 may improve the quality of the traffic using any suitable technique, such as 3R regeneration, and may modify the traffic through wavelength conversion or traffic grooming (such as sub-wavelength grooming). For wavelength conversion, regenerator 122 may perform the conversion in the optical domain or may perform the conversion between optical and electrical domains. The component used as regenerator 122 may affect in which domain the conversion occurs. For example, if regenerator 122 is a tunable transponder, the wavelength conversion occurs from the optical domain to the electrical domain back to the optical domain.

An optical loop back between WSSs 102 and 104 provides for the above-mentioned advantages. Additionally, optical impairments, such as dispersion and polarization mode dispersion, may be reduced, which improves optical reach and performance. Another advantage of the optical loop back includes improving blocking performance of network 10, which reduces wavelength contention.

In an exemplary embodiment of operation, traffic on fiber 21n is transmitted from WSS 104n to WSS 118. WSS 118 provides the constituent channels of the traffic to regenerator 122. Regenerator 122 improves the quality of and/or modifies the traffic using any suitable technique and transmits each channel to WSS 120, which combines the constituent channels into a WDM signal. The signal travels on fiber 21n to WSS 102n. Although described with respect to input fiber 21n, traffic needing regeneration from any input fiber 21 may be sent to output fiber 21n for regeneration. After regeneration, the traffic is then sent to the appropriate output fiber 21 using WSS 102n. Furthermore, any output fiber 21 and associated WSS 102 may be involved in the regeneration. The operation as described in conjunction with FIG. 2 is then implemented on the regenerated traffic.

Modifications, additions, and omissions may be made to node 100. For example, any suitable optical components may replace WSSs 102 and 106, such as splitters. As another example, node 100 may operate without an OXC 116 and have a similar structure as node 20 with the addition of an optical loop back. As yet another example, WSSs 118 and 120 may be a demultiplexer and a multiplexer, respectively. The components of node 50 may be integrated or separated according to particular needs. Moreover, the operations of node 50 described may be performed by more, fewer, or other components without departing from the scope of the present disclosure.

Although the present invention has been described with several embodiments, various changes and modifications may be suggested to one skilled in the art. It is intended that the present invention encompass such changes and modifications as fall within the scope of the appended claims.

What is claimed is:

1. An optical node, comprising:
a plurality of optical input components operable to receive a plurality of signals communicated in an optical mesh network;
a plurality of optical drop components coupled to the plurality of optical input components, each optical drop component operable to select a signal to drop to one or more associated client devices from any one of the plurality of optical input components;
a plurality of optical output components operable to transmit a plurality of signals to be communicated in the optical mesh network; and
a plurality of optical add components coupled to the plurality of optical output components and operable to transmit copies of a plurality of optical add signals to the plurality of optical output components, wherein each optical output component is operable to select a signal to communicate in the optical mesh network received from any one of the plurality of optical add components and the plurality of optical input components.

2. The optical node of claim 1, wherein:
each optical input component comprises a splitter;
each optical drop component comprises a wavelength selective switch (WSS) and a demultiplexer, the WSS coupled to each optical input component and operable to select a signal from one of the optical input components and forward the selected signal to the demultiplexer;
each optical output component comprises a WSS; and
each optical add component comprises a splitter and a multiplexer, the splitter coupled to each optical output component and operable to receive an optical add signal from the multiplexer and forward a copy of the optical add signal to the plurality of optical output components.

3. The optical node of claim 1, wherein at least one of the optical input component and the optical add component comprises a selected one of:
a coupler coupled hierarchically to one or more WSSs;
a coupler coupled hierarchically to one or more couplers; and
a WSS coupled hierarchically to one or more WSSs.

4. The optical node of claim 1, wherein at least one of the optical drop component and the optical output component comprises a selected one of:
a coupler coupled hierarchically to one or more WSSs; and
a WSS coupled hierarchically to one or more WSSs.

5. The optical node of claim 1, wherein:
each optical input component comprises a WSS;
each optical drop component comprises a WSS and a demultiplexer, the WSS coupled to each output input component and operable to select a signal from one of the optical input components and forward the selected signal to the demultiplexer;
each optical output component comprises a WSS; and
each optical add component comprises a WSS and a multiplexer, the WSS coupled to each optical output component and operable to receive an optical add signal from the multiplexer and forward a copy of the optical add signal to the plurality of optical output components.

6. The optical node of claim 5, wherein at least one of the optical input component, the optical drop component, the optical add component, and the optical output component comprises a selected one of:
a coupler coupled hierarchically to one or more WSSs; and
a WSS coupled hierarchically to one or more WSSs.

7. The optical node of claim 1, further comprising an optical regeneration component coupled to an optical input component and an optical output component and operable to facilitate regeneration of a signal.

8. The optical node of claim 7, wherein the optical regeneration component is further operable to convert a wavelength of a signal.

9. The optical node of claim 7, wherein the optical regeneration component is further operable to groom a signal.

10. The optical node of claim 7, wherein the optical regeneration component comprises a selected one of:
a first WSS coupled to a regenerator and the regenerator coupled to a second WSS; and
a demultiplexer coupled to a regenerator and the regenerator coupled to a multiplexer.

11. The optical node of claim 1, further comprising a first optical cross-connect component operable to:
couple the plurality of optical input components to the plurality of optical drop components;
couple the plurality of optical output components to the plurality of optical add components; and
couple the plurality of optical input components to the plurality of optical output components.

12. The optical node of claim 11, further comprising:
a second optical cross-connect component operable to facilitate redundancy of the plurality of optical signals; and
wherein:
each optical input component couples to a coupler, the coupler operable to provide a copy of a signal from the optical input component to the first optical cross-connect component and the second optical cross-connect component;
each optical add component couples to a coupler, the coupler operable to provide a copy of a signal from the optical add component to the first optical cross-connect component and the second optical cross-connect component;
each optical output component couples to a switch, the switch operable to select a signal to transmit from one of the first optical cross-connect component and the second optical cross-connect component to the optical output component; and
each optical drop component couples to a switch, the switch operable to select a signal to transmit from one of the first optical cross-connect component and the second optical cross-connect component to the optical drop component.

13. An optical node, comprising:
a plurality of optical input means for receiving a plurality of signals communicated in an optical mesh network;
a plurality of optical drop means coupled to the plurality of optical input means, each optical drop means for selecting a signal to drop to one or more associated client devices from any one of the plurality of optical input means;
a plurality of optical output means for transmitting a plurality of signals to be communicated in the optical mesh network; and
a plurality of optical add means coupled to the plurality of optical output means and operable to transmit copies of a plurality of optical add signals to the plurality of optical output means, wherein each optical output means for selecting a signal to communicate in the optical mesh network received from any one of the plurality of optical add means and the plurality of optical input means.

14. The optical node of claim 13, wherein:
each optical input means comprises a splitter;
each optical drop means comprises a wavelength selective switch (WSS) and a demultiplexer, the WSS coupled to each optical input means and operable to select a signal from one of the optical input means and forward the selected signal to the demultiplexer;
each optical output means comprises a WSS; and
each optical add means comprises a splitter and a multiplexer, the splitter coupled to each optical output means and operable to receive an optical add signal from the multiplexer and forward a copy of the optical add signal to the plurality of optical output means.

15. The optical node of claim 13, wherein at least one of the optical input means and the optical add means comprises a selected one of:
a coupler coupled hierarchically to one or more WSSs;
a coupler coupled hierarchically to one or more couplers; and
a WSS coupled hierarchically to one or more WSSs.

16. The optical node of claim 13, wherein at least one of the optical drop means and the optical output means comprises a selected one of:
a coupler coupled hierarchically to one or more WSSs; and
a WSS coupled hierarchically to one or more WSSs.

17. The optical node of claim 13, wherein:
each optical input means comprises a WSS;
each optical drop means comprises a WSS and a demultiplexer, the WSS coupled to each output input means and operable to select a signal from one of the optical input means and forward the selected signal to the demultiplexer;
each optical output means comprises a WSS; and
each optical add means comprises a WSS and a multiplexer, the WSS coupled to each optical output means and operable to receive an optical add signal from the multiplexer and forward a copy of the optical add signal to the plurality of optical output means.

18. The optical node of claim 17, wherein at least one of the optical input means, the optical drop means, the optical add means, and the optical output means comprises a selected one of:
a coupler coupled hierarchically to one or more WSSs; and
a WSS coupled hierarchically to one or more WSSs.

19. The optical node of claim 13, further comprising an optical regeneration means coupled to an optical input means and an optical output means, the optical regeneration means for facilitating regeneration of a signal.

20. The optical node of claim 19, the optical regeneration means for converting a wavelength of a signal.

21. The optical node of claim 19, the optical regeneration means for grooming a signal.

22. The optical node of claim 19, wherein the optical regeneration means comprises a selected one of:
a first WSS coupled to a regenerator and the regenerator coupled to a second WSS; and
a demultiplexer coupled to a regenerator and the regenerator coupled to a multiplexer.

23. The optical node of claim 13, further comprising a first optical cross-connect means for:
coupling the plurality of optical input means to the plurality of optical drop means;
coupling the plurality of optical output means to the plurality of optical add means; and
coupling the plurality of optical input means to the plurality of optical output means.

24. The optical node of claim 23, further comprising:
a second optical cross-connect means for facilitating redundancy of the plurality of optical signals; and
wherein:
each optical input means couples to a coupler, the coupler operable to provide a copy of a signal from the optical input means to the first optical cross-connect means and the second optical cross-connect means;
each optical add means couples to a coupler, the coupler operable to provide a copy of a signal from the optical add means to the first optical cross-connect means and the second optical cross-connect means;
each optical output means couples to a switch, the switch operable to select a signal to transmit from one of the first optical cross-connect means and the second optical cross-connect means to the optical output means; and
each optical drop means couples to a switch, the switch operable to select a signal to transmit from one of the first optical cross-connect means and the second optical cross-connect means to the optical drop means.
